(19) United States
(12) Patent Application Publication
(10) Pub. No.: US 2019/0153969 A1
(43) Pub. Date: May 23, 2019

(54) SYSTEM AND METHOD FOR EMISSIONS DETERMINATION AND CORRECTION

(71) Applicant: TOYOTA MOTOR EUROPE, Brussels (BE)

(72) Inventors: Julie LE LOUVETEL-POILLY, Brussels (BE); Julien BOUILLY, Brussels (BE); Kotaro MAEDA, Brussels (BE); Francois LAFOSSAS, Brussels (BE)

(73) Assignee: TOYOTA MOTOR EUROPE, Brussels (BE)

(21) Appl. No.: 16/313,363

(22) PCT Filed: Jun. 7, 2017
(86) PCT No.: PCT/EP2017/063787

§ 371 Date: Dec. 26, 2018

(51) Int. Cl. F02D 41/14; G05B 13/04; G05B 13/02; F02D 41/24; F01N 3/20

(52) U.S. Cl. CPC F02D 41/1405; G05B 13/048; G05B 13/0265; F02D 41/1462; F02D 41/1453; G06F 17/5095; F02D 41/1458; F02D 41/1475; F02D 41/2438; F01N 3/206; F02D 41/1459

(57) ABSTRACT

A method for modelling engine emissions output is provided. The method includes determining a stoichiometric engine output emission value based on a dynamic data-based model and parameters associated with at least one engine operating state, wherein the at least one engine operating state is calculated at a substantially stoichiometric air-fuel ratio, selecting a target air-fuel ratio based on the at least one engine operating state and a desired engine performance, applying a predetermined static model to determine a correction factor to the stoichiometric engine output emission value, based on the target air-fuel ratio, and applying the correction factor to the determined stoichiometric engine output emission value to yield an air-fuel-ratio-corrected emission output value.

### FIELD OF THE DISCLOSURE

The present disclosure is related to simulation and prediction of gasoline engine emissions, and more particularly to evaluation of control logic modifications impact on such emissions.

### BACKGROUND OF THE DISCLOSURE

In order to reduce harmful emissions, e.g., tailpipe emissions, authorities throughout the world have begun to cooperate to put in place standard methods for measuring various emissions from polluting sources during various hypothetical driving cycles. Two of these standard methods, World Harmonized Light Duty Vehicle Test Cycle (WLTC) and Real Driving Emissions (RDE), have come to the forefront as test methods for determining compliance of a particular vehicle with regard to implemented regulations.

Because more and more emphasis is being placed on reduction of vehicle emissions, the desire to determine the effects of control modifications on internal combustion engines at design time has become an important aspect of the design process.

Typically, air-fuel ratio values of gasoline engines can be controlled to optimize the performance of the vehicle and/or the exhaust after treatment system, among others. Such controls typically impose lean or rich air-fuel ratio targets that subsequently modify the engine out emissions. This control depends on Exhaust after-treatment design/condition (new/aged . . . ) and on driving cycle conditions, for example.

At design time, the primary engine output emissions (e.g., NOx, CO, and HC) can be simulated at stoichiometry (i.e., λ=1) based on a series of inputs, e.g., engine speed, air mass, and fuel mass. This simulation can provide some insight into engine output emissions over a variety of driving ranges, and therefore, lead to a suitable exhaust after treatment (EAT) design.

U.S. Pat. No. 4,964,271 discloses an air-fuel ratio feedback control system including at least one air-fuel ratio sensor downstream of a catalyst converter provided in an exhaust gas passage, an actual air-fuel ratio is controlled in accordance with the output of the downstream-side air-fuel ratio sensor. When at least one of the air-fuel ratio feedback control conditions for the downstream-side air-fuel ratio sensor is not satisfied the controlled air-fuel ratio is made an air-fuel ratio by an open loop control, while all the air-fuel ratio feedback control conditions for the downstream-side air-fuel ration sensor are satisfied the controlled air-fuel ratio is made the stoichiometric ratio (λ=1) in accordance with the output of the downstream-side air-fuel ratio sensor. For a period after all the air-fuel ratio feedback control conditions for the downstream-side air-fuel ratio sensor are satisfied, the control by the output of the downstream-side air-fuel ratio sensor is prohibited, but, the controlled air-fuel ratio is made the stoichiometric ratio (λ=1) by an open loop control or by the output of an upstream-side air-fuel ratio sensor.

However, for various reasons, engines may not operate at stoichiometry, for example, depending on certain performance demands of a vehicle operator. Therefore, the simulation values provided at stoichiometry may only be a rough approximation of true engine emissions output.

### SUMMARY OF THE DISCLOSURE

The present inventors have recognized that it is desirable to, within the scope of real driving emission prediction by simulation, predict and/or determine instantaneous emissions (engine out and tailpipe) for any pattern of driving conditions and exhaust after-treatment designs.

In order to do so, a model based design can be used to reduce vehicle testing time by combining an engine out emission prediction with exhaust after-treatment models.

In addition, the inventors have determined that by combining a dynamic stoichiometric model with a static model capable of providing a correction factor based on driving inputs, accuracy of engine out emissions depending on targeted air-fuel (AF) ratio can be greatly enhanced.

According to embodiments of the present disclosure, a method for modelling engine emissions output is provided. The method includes determining a stoichiometric engine output emission value based on a dynamic data-based model and parameters associated with at least one engine operating state, wherein the at least one engine operating state is calculated at a substantially stoichiometric air-fuel ratio, selecting a target air-fuel ratio based on the at least one engine operating state and a desired engine performance, applying a predetermined static model to determine a correction factor to the stoichiometric engine output emission value, based on the target air-fuel ratio, and applying the correction factor to the determined stoichiometric engine output emission value to yield an air-fuel-ratio-corrected emission output value.

The engine output emission may include at least one of CO, NOx, and HC.

The method may include selecting an exhaust after treatment system based on the air-fuel-ratio-corrected emission output.

The method may include controlling an oxygen amount provided to an exhaust after treatment system based on the air-fuel-ratio-corrected emission output and at least one characteristic of the exhaust after treatment system.

The method may include training the dynamic data-based model based on a subset of M virtual data points, wherein M for determining one actual data point is preferably between 50 and 200.

Parameters associated with the engine operating state may include engine rotational speed, air-mass flow, and fuel-mass flow.

Applying the static model may include analyzing engine rotational speed, volumetric efficiency, and target air-fuel ratio to determine an operating point relative to the static model and determining, from a data map of the static model, a correction factor corresponding to the operating point.

Applying the correction factor may include multiplying the correction factor by the stoichiometric engine output emission value to obtain the air-fuel-ratio-corrected emission output.

According to embodiments of the present disclosure, a use of the systems and/or methods to design a powertrain/exhaust after-treatment system for a vehicle is described.

Still further embodiments of the present disclosure describe an engine control unit configured to carry out the systems and/or methods.

According to yet further embodiments of the disclosure, a system for modelling engine emissions output is provided. The system includes processing means configured to determine a stoichiometric engine output emission value based on a dynamic data-based model and parameters associated with at least one engine operating state, wherein the at least one engine operating state is calculated at a substantially stoichiometric air-fuel ratio, select a target air-fuel ratio based on the at least one engine operating state and a desired engine performance, apply a predetermined static model to determine a correction factor to the stoichiometric engine output emission value, based on the target air-fuel ratio, and apply the correction factor to the determined stoichiometric engine output emission value to yield an air-fuel-ratio-corrected emission output value.

The engine output emission may include at least one of CO, NOx, and HC.

The processing means may be configured to control an oxygen amount provided to an exhaust after treatment system based on the air-fuel-ratio-corrected emission output and at least one characteristic of the exhaust after treatment system.

Parameters associated with the engine operating state may include engine rotational speed, air-mass flow, and fuel-mass flow.

The processing means may be configured to analyze engine rotational speed, volumetric efficiency, and target air-fuel ratio to determine an operating point relative to the static model, and determining from a data map of the static model, a correction factor corresponding to the operating point.

Applying the correction factor may include multiplying the correction factor by the stoichiometric engine output emission value to obtain the air-fuel-ratio-corrected emission output.

It is intended that combinations of the above-described elements and those within the specification may be made, except where otherwise contradictory.

The accompanying drawings, which are incorporated in and constitute a part of this specification, illustrate embodiments of the disclosure and together with the description, and serve to explain the principles thereof.

### BRIEF DESCRIPTION OF THE DRAWINGS

FIG. 1 shows an exemplary representation of a modelled gasoline powertrain and emissions system according to embodiments of the present disclosure;

FIG. 2 shows a schematic representation of an exemplary correction routine according to embodiments of the present disclosure;

FIG. 3 shows a flowchart highlighting an exemplary method according to the disclosure;

FIG. 4A shows an exemplary air/fuel ratio target over a selected driving cycle;

FIG. 4B shows an exemplary correction factor determined according to the present disclosure, for the driving conditions exemplified in FIG. 4A; and

FIG. 4C shows a graph of a predicted emissions value and a corrected emissions value based on the determined correction factor for a particular operating point.

### DESCRIPTION OF THE EMBODIMENTS

Reference will now be made in detail to exemplary embodiments of the disclosure, examples of which are illustrated in the accompanying drawings. Wherever possible, the same reference numbers will be used throughout the drawings to refer to the same or like parts.

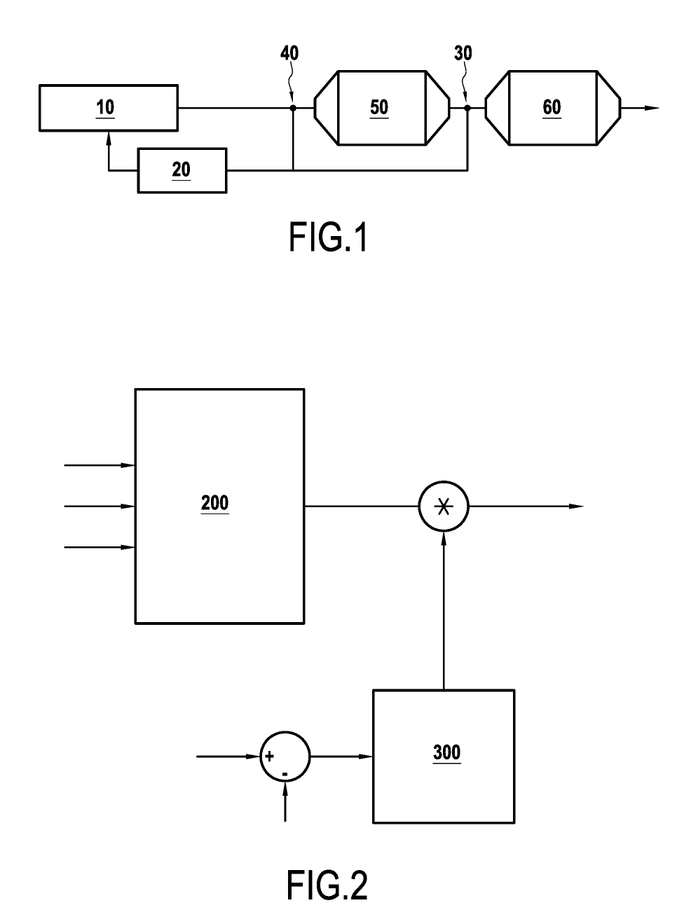

FIG. 1 shows an exemplary representation of a modelled powertrain and emissions system according to embodiments of the present disclosure. As one of skill will come to understand, embodiments of the present disclosure may be implemented both on an actual vehicle comprising real-world components as described herein, or within a vehicle “simulator” capable of simulating real driving conditions and real-world components, i.e., a simulated powertrain. For example, ASCMO software from ETAS provides one such system capable of modelling according to the present disclosure, and the presently disclosed embodiments may be simulated using such software. Other modelling solutions may also be implemented as desired, for example, SIMULINK from MathWorks, or any other suitable simulator capable of simulating engine functionality and outputting result information. With this understanding, the present disclosure will be generally undertaken in the context of a real-world vehicle, however, the disclosure is equally applicable in a simulated environment, and results of such a simulated environment can be used to accurately design a real-world powertrain and EAT system combination.

A powertrain according to the present disclosure may include an engine 10, an electronic control unit (ECU) 20, an air/fuel sensor 40, an O2 sensor 30, an upstream catalyst 50, and a downstream catalyst 60.

Engine 10 may comprise any suitable combustion engine configured to power a vehicle, for example, a gasoline engine, natural gas, etc. Engine 10 may be linked to one or more transmissions configured to transfer rotational energy of engine 10 to wheels or other driving means of the vehicle. Because load on engine 10 varies according to driving conditions and demands, among others, engine 10 may be configured to operate at any number of operating states, an operating state being defined by at least an engine rotational speed, an air mass flow to engine 10, a fuel mass flow to engine 10, a volumetric efficiency of engine 10, and a target air-fuel ratio. One of skill will understand that additional parameters may define an operating state of engine 10, but that the presently described parameters are useful for purposes of the present disclosure.

ECU 20 may be configured as processing means to receive information related to vehicle operation (either real-world or simulated) and to provide commands related to continued operation of the vehicle. For example, ECU 20 may be configured to determine an engine operating stated based on inputs to ECU 20, the inputs comprising, for example, an engine rotational speed N, an air mass flow, a fuel mass flow, target air-fuel ratio, and volumetric efficiency, among others.

ECU 20 may further comprise and/or be linked with a memory (not shown) configured to store information related to the vehicle, for example, data maps related to operating conditions, target air/fuel ratios, mass flows (e.g., air and fuel), as well as various algorithms and data-based models (e.g., dynamic and static) for determining output emissions and corrections, as will be described in greater detail below.

FIG. 2 shows a schematic representation of an exemplary correction routine according to embodiments of the present disclosure.

According to embodiments of the invention, a dynamic data-based model 200 is implemented and used in conjunction with parameters associated with at least one engine operating state, for determining a stoichiometric engine output emission value. The dynamic data-based model 200 is used to predict, for example, instantaneous CO, HC and NOx emissions at any particular operating condition of an engine, with the assumption that the engine is operating substantially at stoichiometry (i.e., λ=1).

The dynamic data-based model 200 may be trained using, for example, data provided as output from chassis dynamometer tests. The data correspond to engine emission components desired for analysis, for example, CO, NOx, and HC, among others.

Importantly, a training domain should be broad enough in terms of operating conditions and transient conditions (gradient of engine speed, air mass flow and fuel flow) so as to be predictive for a variety of driving conditions that may be envisaged for the vehicle. Such measurements should be carried out at stoichiometry. For example, according to some embodiments, training using one or more sets of existing driving cycles, e.g., NEDC/MVEG, TUV (e.g., Severe), RPA95, WLTC, and/or RDE cycles, can be used to generate the training data for the dynamic data-based model.

Training may take place at one or more ambient temperatures, for example, 14 degrees C. and 25 degrees C.

One of skill in the art will understand that the techniques for training a dynamic model may be specific to the software used for implementing the system (e.g., ASCMO, SIMULINK, etc.) Therefore, such training techniques will not be discussed herein, as one of skill in the art understands the specifics of the individual software.

Once a dynamic data-based model 200 has been trained, the model can be validated using one or more driving cycles to check output information based on the operating state data input. For example, a dynamic data-based model 200 trained using RPA95, NEDC and TUV data sets, can then be validated by inputting engine operating state parameters (e.g., engine rotational speed, air mass flow, and fuel mass flow) from a WLTC driving cycle and the components of emission outputs of the dynamic data-based model 200 (e.g., instantaneous CO, HC and NOx emissions in ppm) compared against expected outputs of the engine configuration at the various operating states, in order to determine correspondence and validity of the training.

Validation of the dynamic data-based model 200 may be undertaken at all temperatures used for training, e.g., 14 degrees C. and 25 degrees C., or a subset thereof.

The parameters associated with at least one engine operating state may include, for example, parameters associated with the engine operating state comprise a engine rotational speed, air-mass flow, and fuel-mass flow, for example at a point in time.

According to some embodiments, particularly when using ASCMO from ETAS, it may be helpful to consider using a subset of data points for training of the dynamic data-based model 200, the subset being defined by the user. For example, the information contained within a subset can be reduced to a set of M virtual basis points, e.g., 50<M<200 points.

Further, dimensionality reduction may be implemented, for example, Principal Component Extraction (PCA) in order to reduce the number of inputs to be computed by the dynamic data-based model 200 during the training and/or the predictive operations. For example, when implemented using the ASCMO software package, the values of M mentioned above may be reduced by up to 50 percent.

A static model 300 may be implemented to determine a correction factor to the stoichiometric engine output emission value predicted by the dynamic data-based model 200 described above, based on a target air-fuel ratio, among others.

Primary inputs to the static model 300 may include engine rotational speed, volumetric efficiency, and a target air-fuel ratio, for example, with primary outputs being a delta (i.e., difference) for CO, NOx, and HC (i.e., ΔCO, ΔNOx, and ΔHC). These delta values may be used to correct the determination of the dynamic model as will be described below.

Similarly to the dynamic data-based model 200, the static model 300 may be implemented in ASMCO (e.g., ASC GP model), Simulink, or other suitable simulator. A variety of lambda points may be used for creating data maps yielding the delta values of each emission component for which analysis is desired, e.g., ΔCO, ΔNOx, and ΔHC, and these values used to train the static model 300.

In order to train and calibrate an exemplary static model 300, emission maps were created at 6 different target air-fuel ratios (λ_{target}), e.g., 1.05, 1.01, 1.0, 0.99, 0.95, and 0.86, during an engine bench mapping procedure, and the ASC GP model trained on these maps. A map is created for each emission component for which values are desired, for example, CO, NOx, and HC. The maps are created by taking a measured value of each engine emission during the bench testing (e.g., CO, NOx, HC, etc.) at the target air fuel ratio and correlating the resulting value with an engine emission value for that emission component at the same operating conditions, but at a stoichiometric air-fuel ratio.

The map can then be validated at, for example, 9 different target air-fuel ratios Additional points at different air fuel ratios are previously measured. One of skill will recognize that more or fewer validation points may be used.

The correction factor may then be predicted by the static model 300 at such points with target air-fuel ratio set accordingly can be compared to the measured values to validate the static model prediction.

The static map values so created may be converted to correction map values relative to the stoichiometric emissions output by applying equation (1) to each engine emission output value:

CorrectionFactor_i=(MapValue_i−MapValue_stoichio)/MapValue_stochio (1)

where CorrectionFactor_i corresponds to the correction for any one of the emission components, i is the reference target air-fuel ratio, MapValue_i is the map value at the reference target air-fuel ratio, and MapValue_stoichio is the map value at the stoichiometric air-fuel ratio. The resulting values are then stored as maps in the static model 300, and subsequently used for determining a correction factor to be applied.

Once the dynamic data-based model 200 and the static model 300 have been configured, determination of an air-fuel-ratio-corrected emission output value is possible, either during operation of a vehicle or during simulation of operation of a vehicle.

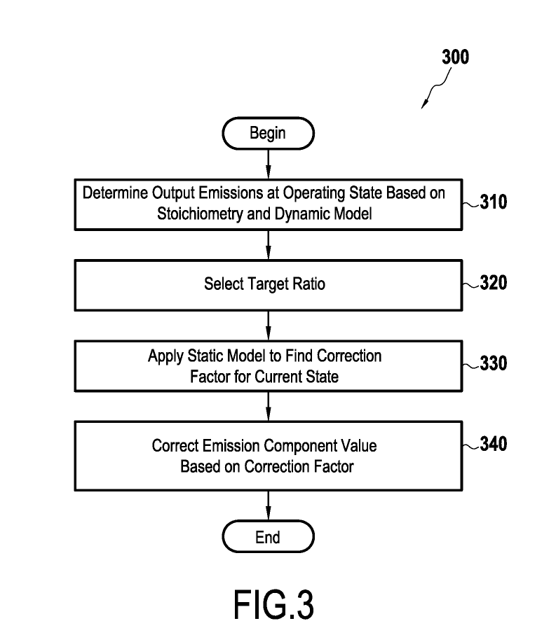

Particularly, turning to FIG. 3, a stoichiometric engine output emission value may be determined based on inputs to the dynamic data-based model at any desired operating point by providing an engine rotational speed, air mass flow, and fuel mass flow, and assuming operation at stoichiometry (step 310).

Based on the engine operating state selected, a target air-fuel ratio (λ_{target}) may be determined based on, for example, desired performance of exhaust after-treatment systems (step 320). For example, rich pulse can be targeted after fuel cut to decrease the oxygen content in a three way catalyst.

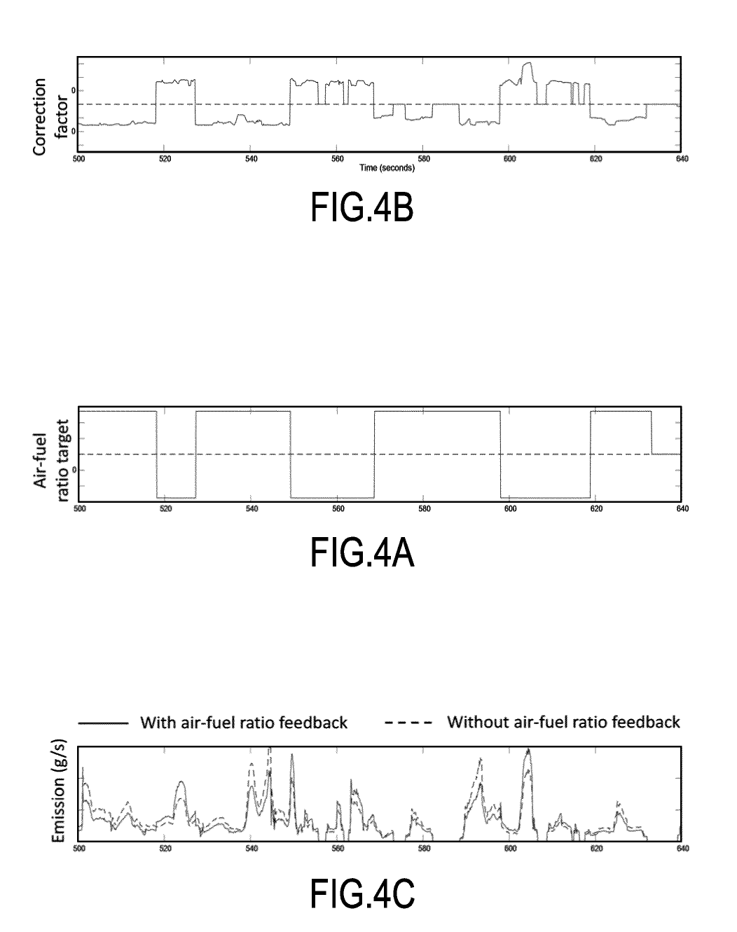

Once the target air-fuel ratio has been determined, the static model may be applied to find a correction factor based on the target air-fuel ratio feedback (step 330). For example, FIG. 4A shows an exemplary air/fuel ratio target over a selected driving cycle.

The corrective static map having already been created by use of equation (1) noted above, the factor Map_Correction corresponding to a particular operating point may be obtained from the map and used as the correction value as described below.

FIG. 4B shows an exemplary correction factor determined according to the present disclosure, for the driving conditions exemplified in FIG. 4A.

Once the correction value for a particular operating state and target fuel ratio has been determined, it may be applied to the stoichiometric engine emissions value provided by the dynamic data-based model for the same operating state, and the air-fuel-ratio-corrected emission output value obtained (step 340).

In order to “feedback” the target air-fuel ratio information to make the corrected emission determination for each emission component desired (e.g., CO, NOx, HC, etc.), the following equations may be used (exemplary for CO, NOx, and HC):

CO_i=CO_stoichio*(1+CO_CorrectionFactor_i)

NOx_i=NOx_stoichio*(1+NOx_CorrectionFactor_i)

HC_i=HC_stoichio*(1+HC_CorrectionFactor_i)

where CO_i is the corrected CO emissions, NOx_i is the corrected NOx emissions, and HC_i is the corrected HC emissions.

FIG. 4C shows a graph of a predicted emissions value and a corrected emissions value based on the determined correction factor for a particular operating point calculated as described above. As one of skill can understand from FIG. 4C, the accuracy improvement based on the target air-fuel ratio feedback, over just the stoichiometric values is on the order of greater than 10 percent, and at some points greater than 50 percent.

Thus, by implementing a system and method according to the present disclosure, it may be possible to determine substantially more accurate instantaneous emissions determinations/predictions. In turn it therefore becomes possible to more accurately select exhaust treatment catalysts 50 and 60 at design time to meet regulatory and performance demands. This is particularly useful when simulations are utilized.

During real-world operation of a vehicle, based on information from air-fuel sensor 40, O₂ sensor 30, and the determined air-fuel-ratio-corrected emission output value, it may be possible to adjust the amount of O₂ provided to the exhaust after treatment catalysts, thereby further improving engine emission output.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

1. A method for modelling engine emissions output, the method comprising:
determining a stoichiometric engine output emission value based on a dynamic data-based model and parameters associated with at least one engine operating state, wherein the at least one engine operating state is calculated at a substantially stoichiometric air-fuel ratio;
selecting a target air-fuel ratio based on the at least one engine operating state and a desired engine performance;
applying a predetermined static model to determine a correction factor to the stoichiometric engine output emission value, based on the target air-fuel ratio; and
applying the correction factor to the determined stoichiometric engine output emission value to yield an air-fuel-ratio-corrected emission output value.

2. The method according to claim 1, wherein the engine output emission comprises at least one of CO, NOx, and HC.

3. The method according to claim 1, comprising selecting an exhaust after treatment system based on the air-fuel-ratio-corrected emission output.

4. The method according to claim 1, comprising controlling an oxygen amount provided to an exhaust after treatment system based on the air-fuel-ratio-corrected emission output and at least one characteristic of the exhaust after treatment system.

5. The method according to claim 1, comprising training the dynamic data-based model based on a subset of M virtual data points, wherein M for determining one actual data point is preferably between 50 and 200.

6. The method according to claim 1, wherein parameters associated with the engine operating state comprise engine rotational speed, air-mass flow, and fuel-mass flow.

7. The method according to claim 1, wherein applying the static model comprises:
analyzing engine rotational speed, volumetric efficiency, and target air-fuel ratio to determine an operating point relative to the static model; and
determining, from a data map of the static model, a correction factor corresponding to the operating point.

8. The method according to claim 1, wherein applying the correction factor comprises multiplying the correction factor by the stoichiometric engine output emission value to obtain the air-fuel-ratio-corrected emission output.

9. Use of the method according to claim 1 to design a powertrain/exhaust after-treatment system for a vehicle.

10. An engine control unit configured to carry out the method according to claim 1.

11. A system for modelling engine emissions output, the system comprising:
processing means configured to:
determine a stoichiometric engine output emission value based on a dynamic data-based model and parameters associated with at least one engine operating state, wherein the at least one engine operating state is calculated at a substantially stoichiometric air-fuel ratio;
select a target air-fuel ratio based on the at least one engine operating state and a desired engine performance;
apply a predetermined static model to determine a correction factor to the stoichiometric engine output emission value, based on the target air-fuel ratio; and
apply the correction factor to the determined stoichiometric engine output emission value to yield an air-fuel-ratio-corrected emission output value.

12. The system according to claim 11, wherein the engine output emission comprises at least one of CO, NOx, and HC.

13. The system according to claim 11, wherein the processing means is configured to control an oxygen amount provided to an exhaust after treatment system based on the air-fuel-ratio-corrected emission output and at least one characteristic of the exhaust after treatment system.

14. The system according to claim 11, wherein parameters associated with the engine operating state comprise engine rotational speed, air-mass flow, and fuel-mass flow.

15. The system according to claim 11, wherein the processing means is configured to
analyze engine rotational speed, volumetric efficiency, and target air-fuel ratio to determine a an operating point relative to the static model; and
determining, from a data map of the static model, a correction factor corresponding to the operating point.

16. The system according to claim 11, wherein applying the correction factor comprises multiplying the correction factor by the stoichiometric engine output emission value to obtain the air-fuel-ratio-corrected emission output.
